(19) United States
(12) Patent Application Publication
(10) Pub. No.: US 2011/0131921 A1
(43) Pub. Date: Jun. 9, 2011

(54) SYNTHETIC DOOR WITH IMPROVED FIRE RESISTANCE

(76) Inventor: KUEI YUNG WANG CHEN, TAIPEI (TW)

(21) Appl. No.: 12/633,177

(22) Filed: Dec. 8, 2009

(51) Int. Cl. E06B 5/16

(52) U.S. Cl. 52/784.1

(57) ABSTRACT

Using integrally formed stiles on skins of sheet molded plastics (thermosetting) employed to form the exterior surfaces of a synthetic door having sheets of reinforcing materials adhered to the inner surface of each of the skins, the skins can be connected through the integral stiles and slats of a fire proof materials can be affixed to these stiles and rails closing the top and bottom opening between the skins to increase the fire resistance of the resulting door when the core is filled with a phenolic foam. The structure described reduces the weight of the resulting door and places the fire resistant materials around the door edges which are the most susceptible to failure during a fire while structurally tying the slats together through the sheets of carbon fiber or fiberglass disposed on the inner surfaces of the skins whereby failure (disintegration) of the skins during a fire will not lead to a collapse of the door as with some prior art door structures. A slat of polyvinyl chloride can be employed to cover the fire proof slats so the door edges can be trimmed so it will fit into the door frame and the edges will be pleasingly attractive.

### BACKGROUND

Synthetic doors, those made of thermoset plastics with skins formed by using a sheet molded composition (SMC), a bulk molded composition (BMC) or fiber reinforced plastic composition (FRPC), have become very popular in the building trades. The popularity of these doors stems from the fact such doors are lightweight, often have wood graining on their outer surfaces for aesthetic purposes and come in a multitude of panel configurations, the latter being a feature of more expensive doors. Moreover they do not warp, are easy to paint and are impervious to rot and insect attack.

A synthetic door of one type described is disclosed in U.S. Pat. No. 4,864,789 issued to Thorn wherein skins are attached to opposite sides of a rectangular frame. Each of the skins is a compression molded sheet molding compound (SMC) panel which includes 15% to 40% fibrous glass reinforcement, by weight, and 10% to 40% inert material filler, by weight, dispersed in the molding resin. Unsaturated polyester polymers blended with vinyl monomers such as styrene are molding resins that may be cured under heat and pressure form the thermoset compression molded skins. The molding resins include unsaturated polyester resin compositions and modifications as disclosed in, for examples, U.S. Pat. Nos. 3,772,241 and 3,883,612.

Each of the skin of such doors has a thickness of between 0.050 inch and 0.120 inch and are mounted on the rectangular frame with the interior space between the skins filled with a foamed plastic material.

While the above type of synthetic door was the type first introduced, applicant later developed an improved novel door structure that did not employ the rectangular frame described in the Thorn patent, supra. In applicant's development of this novel door type, interlocking projections are formed adjacent to the lengthwise perimeter of the skins at the time they are compression molded. These projection are normal to the interior surface of the skins and extend upward from the interior surface of each skin about half the width of the assembled door. At the distal ends of these projections, an interlocking joint is formed, such as rib on one projection and a groove on the other, that mesh when the skins are assembled the ribs are fitted into the grooves and secured, such as by gluing. Typically these projections are used in place of the stiles. Rails are inserted between the skins at the top and bottom of the door to close the interior or core of the door and fastened in place. There after the core is filled with a foamed plastic. As a result there is no need for a rectangular frame used in conventional construction of doors of this type as taught by Thorn.

A drawback of many such synthetic doors either type described above is their comparative lack of fire resistance with conventional doors, such as those constructed of wood. Under fire conditions the thin skins are often consumed leading the collapse of the door. This lack of fire resistance has been addressed in the prior art by constructing such doors with panels of cementitious material positioned directly beneath the exterior skins of such a door as shown, for example in U.S. Pat. No. 5,816,017 to Hunt et al, that discloses a fire retardant door which includes a core of fire resistant-blocking material, being Tectonite™, having a fire rating of approximately 90 minutes. U.S. Pat. No. 6,115,976 to Gomez discloses an assembly for sealing a fire resistant door within a door frame during a fire event with a plurality intumescent strips within a slots in each door edge. The intumescent strips are designed to expand upon reaching a reaction temperature n a fire event or other extreme heat source.

U.S. Pat. No. 5,417,024 to San Paolo discloses a fire resistant panel door constructed from panels, stiles, intermediate rail and rails having a core of fire resistant material. The door components are joined together so that the fire resistant material extends substantially continuously from side to side and from top to bottom of the finished door. The fire resistant core of each door panel is recessed within the fire resistant core of the associated rails and stiles to reduce hot gas infiltration through the door which can compromise the door's fire resistance.

U.S. Pat. No. 4,930,276 to Bawa et al. discloses a fire door window construction. The fire door includes a trim strip having inner and outer members. The inner member is of a high density incombustible mineral material or ceramic and is nailed in position to securely and uniformly hold the pane of glass in the door opening. An intumescent caulking compound is applied between an inner portion of the outer trim member and the pane of glass. U.S. Pat. No. 4,441,296 to Grabendike et al. discloses a fire resistant wood door structure designed to pass code and testing laboratories' requirements. U.S. Pat. Nos. 4,529,742; 6,031,040; and 6,153,674 all disclose the use of intumescent compounds/fire barrier materials within door construction to reduce or eliminate the passage of smoke and fire gases between the door and door frame. In such doors inert fillers are used in the core such as calcium carbonate or aluminum trihydrate.

While improving fire resistance such interior panels in such prior art doors substantially increase the weight of the door and create difficulties in manufacturing, handling, and installing them.

One of the objects of the current invention is to improve the fire resistance of synthetic doors of the type described without substantially increasing their weight or costs, thereby obtaining the benefits of easier manufacturing, easier handling, and easier installation.

Another object is the provided a synthetic door with appealing exterior surfaces along with increased fire resistance.

A further object is the provision of a design for a synthetic door which allows cheaper materials to be employed in its construction without seriously comprising its fire resistance.

Other objects and advantages of the novel door structure will be apparent form the disclosures in this specification and the accompanying drawings.

### SUMMARY OF THE INVENTION

An improved synthetic door having improved fire resistance includes a first door skin having interior, spaced apart raised projections adjacent to its lengthwise edges, with the first door skin having a reinforcing backing sheet secured to its interior surface, a second door skin having interior, spaced apart, raised projections adjacent to its lengthwise edges, with the second skin having a reinforcing backing sheet secured to the interior surface, with the distal ends of the raised projections operable to interlock and create a space between the reinforcing sheets when assembled, a top rail inserted between the reinforcing sheets at the top of the skins and a bottom rail inserted between the reinforcing sheets at the bottom of the skins, with the rails operable to close the interior between the sheets, and a fire resistance phenolic foam disposed in the hollow interior between the reinforcing sheets along with at least one slat of fire resistance material married to the exterior surfaces of the projections and exterior surfaces of the top and bottom rails plus an outer slat of a polyvinyl chloride material disposed on and attached to the exterior surfaces fire proof slats for aesthetic and trimming purposes.

The reinforcing sheets attached to the interior surfaces of the skins are selected from the group of fiberglass cloth or carbon fiber sheets which decompose at much higher temperatures than the skins to which they are attached and maintain a structural connection between door components even after decomposition of its skins.

### DESCRIPTION OF THE DRAWINGS

FIG. 1 is an exploded perspective of the several components of the novel synthetic door of this invention;

FIG. 2 is a perspective of a corner of the novel door with parts broken away to better illustrate the invention;

FIG. 3 is a broken away cross section of the bottom of the skin components of novel door, showing the relationship of the interlocking integral projections interior surfaces of the skins; and

FIG. 4 is a perspective of a bottom corner of the novel door, with part broken away, showing an intermediate configuration occurring during the assembly if to novel door.

### DESCRIPTION OF AN EMBODIMENT

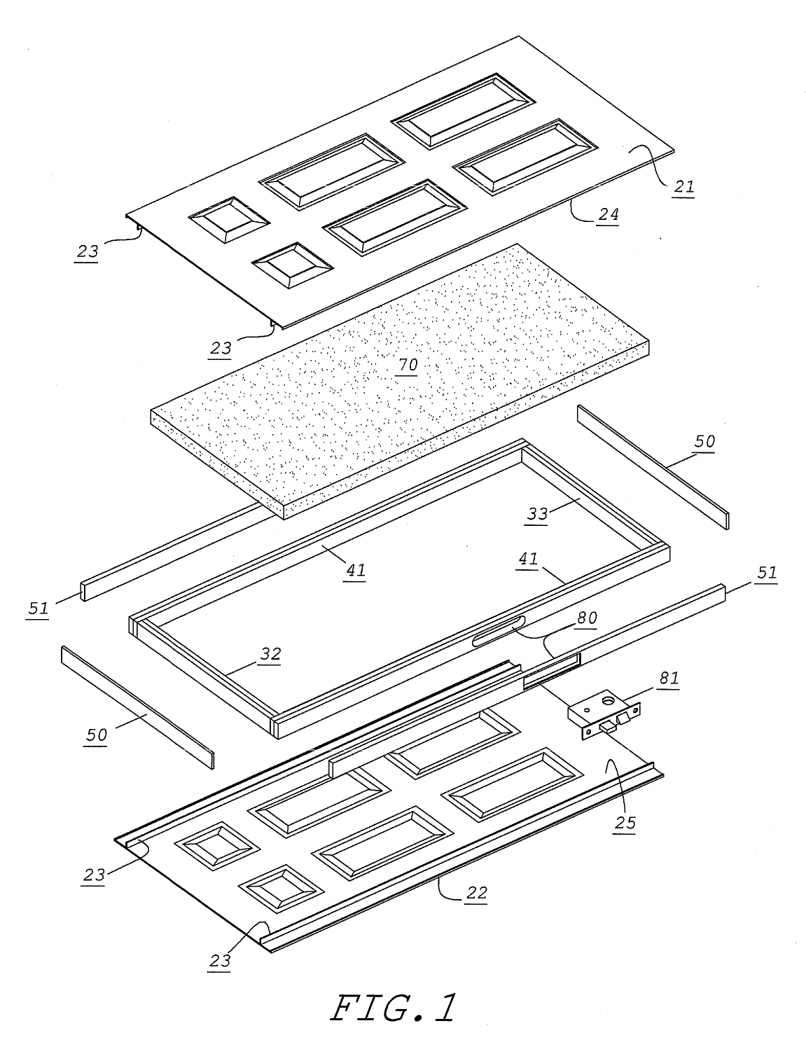

An exploded perspective of novel synthetic door 20 is shown in FIG. 1. As can be seen this door is constructed with out the typical stiles. Constructed of a top skin 21 and a bottom skin 22, both of which have integral projections 23 extending perpendicularly to their respective interior surfaces 24 and 25 and extending lengthwise adjacent to the vertical edges of these skins, the skins are connected through these projections and can be seen in FIG. 4.

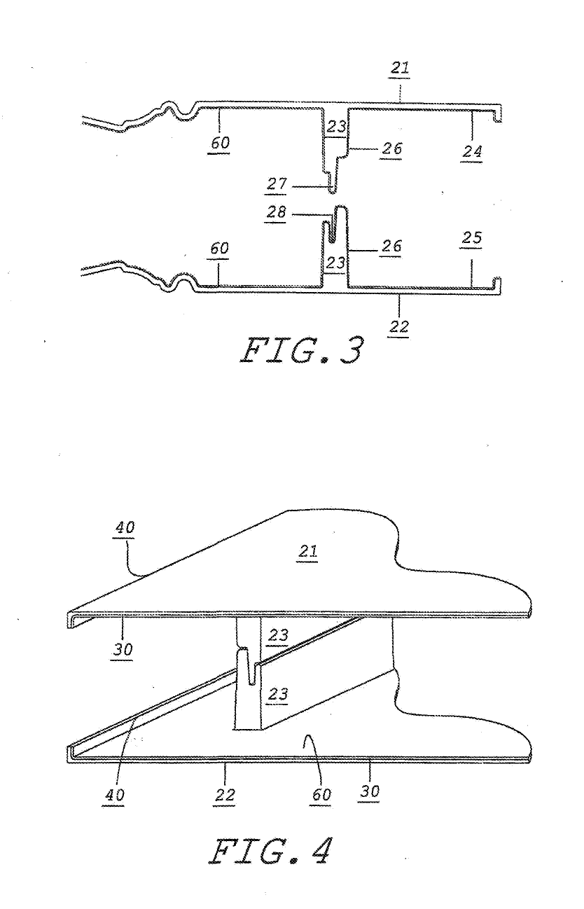

The connection of the skins is shown in FIG. 3. Typically he distal ends 26 of the projections 23 on one sheet will have a rib 27 and the distal ends of the projections on the other sheet will have a groove 28 for receiving the rib. As a result of these configurations the skins can be assembled using this interlock on the distal ends of the projections without a conventional stile. Obviously, other configurations can be used to interlock the top and bottom skins at the distal ends of the projections.

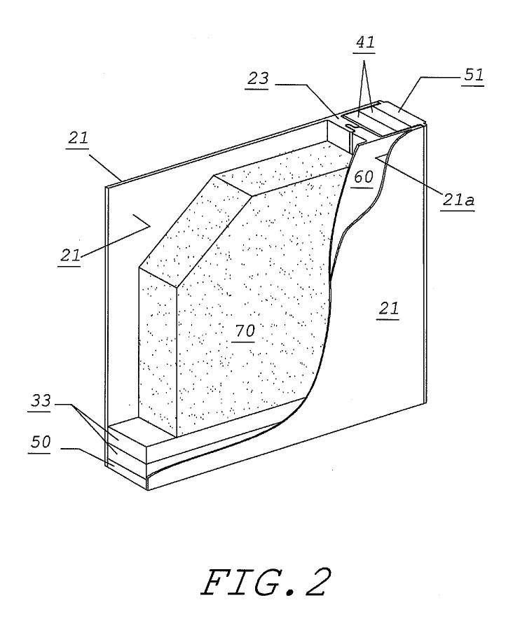

Referring to FIG. 4, showing an intermediate assembly, it can be seen that the lengthwise projections 23, which have been joined as describe in reference to FIG. 3, have been trimmed back from the bottom edges 30 of the skins 21 and 22 so that a rail (not shown in FIG. 4) can be inserted between the reinforcing sheets and secured to the interior surfaces of these skins to close the interior or core 31 of the door 20. The rail can be constructed of wood, or can be fabricated from slats of fire proof material 32 as shown in FIG. 2. Obviously the same arrangement, a rail 33, is used to close the top of the door between the reinforcing sheets whereby the core is completely enclosed.

The afore described skins 21 and 22 are constructed using conventional thermal set molding processes by employing sheet molded compositions (SMC), bulk molded compositions (BMC) or fiber reinforced plastic compositions (FRPC). In such processes the out surfaces of the skin can include wood graining and panels. Typically these skins will have a thickness from 0.050 inches to 0.120 inches when compression molded.

With the skins 21 and 22 joined by the integral projection 23 as described, and the location of these projections inboard of the outer edges 40 of these skins, there is an extension of these edges of the skins beyond the interlocking projections as can be seen in FIG. 4. Between the skins in the area of the extensions, slats 41 of fire proof material is assembled, as shown in FIG. 2, using glue or the like.

It is desirable to add exterior polyvinyl slats 50 and 51 to the exterior edges of the top and bottom rails and fire proof slats for aesthetic reasons and provide a surfaces which can be worked (planed or cut) to fit the door into the door frame. Slats 50 are attached to the top and bottom rails 32 and slats 51 are attached to the slats 41, as can be seen in the exploded perspective in FIG. 1.

A bead of an intumescent material can be placed in a groove (not shown) in outer most of the fireproof slats which will expand as polyvinyl slat is burned away so a large gap does not occur between the edges of the door and its door frame. Such intumescent materials are will known and typically comprise from 40 to 70% by weight of a copolymer of vinyl acetate and ethylene as a flexible polymeric binder, and from 15 to 60% by weight of expandable graphite, the percentages being based on the combined weight of said copolymer and the graphite.

Before the skins 21 and 22 are joined as described in reference to FIG. 3, in one embodiment, a reinforcing sheet 60 is secured to the inner surface 24 and 25 of each these skins. This sheet is selected from carbon fiber sheet and or fiberglass cloth having thicknesses of from 0.03 to 0.08 inches and sized to fully cover the inner surface of these skins. The inner surfaces of the skins can include increased roughness when molded to insure a viable bond between the skins and sheets. Also the skins can be integrally molded with the reinforcing sheet in some cases. It is important to recognize that the reinforcing sheet are selected from materials that have a much higher decomposition temperature than the skins. As a result even if the skin is decomposed by a fire the reinforcing sheet will last considerably longer and maintain the structural integrity of the door so constructed even after the skins are turned to ash.

Once skin and reinforcing sheet are married together, skins 21 and 22 are assembled as described. In all the embodiments, a phenolic foam 70, which itself has very little structural integrity, even though it has good fire resistance qualities, is employed in the core 31, typically by an in place foaming technique.

As can be seen in FIG. 1, opening 80 for a lock set 81 is milled in the vertical vinyl slat 51 and through the vertical fire proof slats 41 to complete the door.

As to the fire proof slats 32, 33 and 41 they are construction of sheet materials of calcium silicate plate, hard wood, and extruded foamed polyvinyl chloride having a thickness from 1 to 3 inches, and glued in place with a fire proof glue such as a phenolic glue or mechanically secured with fasteners. Using multiple slats in place of single wider slat is desirable limit heat transfer across the slats when hot gases engage the edges of the door where there can be some infiltration these gases in the cracks between the door's edges and the door frame.

In general the described invention allows fire proof materials to be disposed at the edges of the door thereby limiting the weight of the door while maintaining the overall integrity of the door by using sheets of carbon fiber and or glass fiber to hold the components together under adverse fire conditions when the skins are compromised by the heat. Moreover the fire proof materials are located at the door edges where the heat is more intense during a fire.

Having described my invention I claim:

1. An improved synthetic door having improved fire resistance comprising:
a first door skin having interior raised projections adjacent to each of its lengthwise edges, said first door skin having a reinforcing sheet secured to its interior surface;
a second door skin having interior raised projections adjacent to each of its lengthwise edges, said second skin having a reinforcing sheet secured to the interior surface;
interlocking means on the distal ends of said raised projections operable to connect said projections when said first and second door skins are assembled on said projections creating a core space between said reinforcing sheets;
a top rail inserted between said reinforcing sheets adjacent to the top of said skins;
a bottom rail inserted between the reinforcing sheets adjacent to the bottom of said skins, said top and bottom rails operable to enclose such core space between said reinforcing sheets;
a fire resistance phenolic foam disposed in such core space between said reinforcing sheets;
at least one slat of fire resistance material affixed to the exterior surfaces of said projections; and
at least one slat of a fire resistance material affixed to the exterior surfaces of said top rail and at least one slat of fire resistance material affixed to exterior surfaces of the bottom rail.

2. The door as defined in claim 1 wherein an outer slat of a polyvinyl chloride material is disposed on and attached to the outer surface of each of the slats of fire proof material.

3. The novel door defined in claim 1 wherein the skins are compression molded with a composition selected form the group of sheet molded compositions (SMC), a bulk molded compositions (BMC) or fiber reinforced plastic composition s (FRPC).

4. The novel door defined in claim 1 wherein the skins have a thickness of form 0.05 to 0.16 inches.

5. The novel door defined in claim 1 wherein the reinforcing sheet covering the internal surfaces of each skin has a thickness of form 0.03 to 0.08 inches and is selected from the group consisting of a carbon fiber sheet and a fiber glass cloth sheet attached to said interior surfaces.

6. The novel door defined in claim 1 wherein the projections have a width of from 0.2 to 0.8 inches.

7. The novel door defined in claim 1 wherein the slats of fire proof material have a thickness from 1 to 3 inches and are selected from the group consisting of calcium silicate plate, hardwoods and extruded polyvinyl chloride.

7. The novel door defined in claim 1 wherein the rails inserted between the reinforcing sheets at the top and bottom of the door are selected from the group consisting of hardwoods, extruded polyvinyl chloride, and fire proof materials such as calcium silicate plate.

8. The novel door defined in claim 1 wherein the outer most slat of fire resistance material contains a bead of intumescent material.
